(19) United States
(12) Patent Application Publication
(10) Pub. No.: US 2007/0109187 A1
(43) Pub. Date: May 17, 2007

(54) Radar Detection, Tracking and Recording System

(76) Inventor: Gary Lee Murphy, Olathe, KS (US)

Correspondence Address: GARY MURPHY, 13632 S. SYCAMORE, OLATHE, KS, 66062, US

(21) Appl. No.: 11/164,231

(22) Filed: Nov. 15, 2005

(51) Int. Cl. G01S 5/14

(52) U.S. Cl. 342/357.13

(57) ABSTRACT

This invention describes a device that will detect the use of radar by law enforcement and combine that information with the current location and time. The information will be recorded and loaded into software database that will aggregate the information for analysis to determine where the use of radar by law enforcement officials is most common.

### BACKGROUND OF THE INVENTION

Law enforcement officials have been using radar to detect the speed of motor vehicles for several decades. Soon after these devices were used, companies began to manufacture devices that would detect and alert drivers to the use of radar by law enforcement. Law enforcement countered through the creation of radar systems that would be activated manually and reducing the efficacy of radar detection systems that were given an early alert with the radar detection systems that operated continuously.

It would be beneficial for drivers to be aware of areas within their expected travels to know where there is a statistically high probability that the use of radar is in use by law enforcement officials. In colloquial terms, this would identify probable “speed traps”.

### SUMMARY OF THE INVENTION

The objective of this invention is to create a device that is capable of recording information about the use and location of radar by law enforcement officials to detect violations in speed limit laws by drivers on the roadways. In addition, this invention describes a process by which the information is aggregated in a database so that analysis could determine the probability of the use of radar. Drivers that are given access to this information would be able to determine where prudence should be used in driving speeds based on the probability that excesses in speed would result in detection by law enforcement officials.

The invention would incorporate products with differing capabilities. All devices would have circuitry, such as that available in consumer radar detection systems, and circuitry available in consumer global positioning satellite (GPS) systems. GPS circuitry is capable of producing the current location and time while active. That time and location information, coupled with the band and signal strength would be recorded on a computer medium, such as, but not limited to, a CF or SD card from which the information could be subsequently transmitted to software that would record and aggregate the information. More advanced devices would also contain wireless networking technology that would enable the information to be transmitted to a separate computer device using wireless networking technology such as, but not limited to, Bluetooth, GSM, CDMA, or 802.11 networking technology.

### DETAILED DESCRIPTION OF THE PREFERRED EMBODIMENT

The basic implementation of the preferred embodiment of the device would consist of circuitry, available in consumer radar detection equipment from companies such as Cobra Electronics Corporation. The device would also contain circuitry that would receive signals from global positioning satellites (GPS). This circuitry is also available in consumer devices from companies such as Garmin International. In addition to the hardware for radar detection and GPS reception, the device would contain a small, embedded software system that would obtain current time and position information from the GPS circuitry and the currently detected radar band and signal strength from the radar circuitry. This information would be recorded on the device in a persistent computer medium so that the information is preserved across power outages. This computer medium could be implemented in the preferred embodiment on a CF or SD card.

When the driver has collected information about the location and use of radar on the CF or SD card, they would remove the card and insert the card into a consumer personal computer capable of reading the information. That data would be uploaded to a service, the preferred embodiment using Internet technology, that would record the information in a database along with information obtained from other users of the device. This data would be analyzed and used to create a representation of the probability that radar is being used by law enforcement (colloquially, a “speed trap”). The preferred embodiment of this information would be to use geospatial mapping software to be able to provide consumers of the information the likelihood of speed traps on their route.

More advanced implementations of the preferred embodiment would also contain wireless networking capabilities. The preferred embodiment could use, but is not limited to, wireless technology such as Bluetooth, CDMA, GSM or 802.11 networking products. These are also commercially available from several consumer computer companies. This more advanced embodiment would use this wireless networking technology to automatically transfer the information from the device to the service that would aggregate data. This would eliminate the manual step of transferring the data from the device to the aggregation service.

As mobile, wireless wide area networking technology, such as CDMA and GSM becomes more ubiquitous, the preferred embodiment of the device could be enhanced. As the driver of the vehicle is mobile, the information from the aggregation service could be broadcast over the wireless wide-area network to present a visual or auditory warning when an area of high probability radar use is being approached. It is also possible that information relating to the use of radar in real-time could be transmitted to drivers that are approaching an area of current radar use, but are not yet within range of the radar detection systems.

It should be appreciated by those who use current radar detection or GPS technologies that the combination of these two information gathering technologies is more powerful that either individually when coupled with information technology that will process the event information as described. It should be realized by those skilled in the art that equivalent constructions do not depart from the spirit and scope of the invention as set forth in the appended claims.

Having thus described our invention, what I claim as new and desire to secure by Letters Patent is set forth in the following claims.

What is claimed is:

1. A device that will record the current time and location at which radar-based speed detection was detected as well as the strength of the signal and the band that was detected. This device will combine the capabilities of existing consumer radar detection with the capabilities of consumer global positional satellite (GPS) technology. When a radar signal is detected, software or firmware residing on the device will make a note of the signal strength and band. Said software or firmware will access information available from GPS circuitry to note the current time and location at which the radar signal was detected. Said software will record or transmit this information for subsequent processing.

2. The method as described in claim 1 that will record the information on a computer medium capable of maintaining the information even if there is removal of power from the device.

3. The method as described in claim 1 that will transmit the information gathered by the device to another computer-based device using wireless networking technology such as, but not limited to, Bluetooth, GSM, or 802.11 networking technology.

4. A software system for aggregating the information obtained as described in claim 1 such that analysis can be done to determine where law enforcement most frequently uses radar to detect speeding.
